(19) United States
(12) Patent Application Publication
(10) Pub. No.: US 2005/0099604 A1
(43) Pub. Date: May 12, 2005

(54) Backlight device and liquid crystal display device therewith

(75) Inventors: Hidetaka Mizumaki, Nara-shi (JP); Kazuya Shimojoh, Matsusaka-shi (JP)

Correspondence Address: KEATING & BENNETT LLP, Suite 312, 10400 Eaton Place, Fairfax, VA, 22030, US

(73) Assignee: Sharp Kabushiki Kaisha, Osaka (JP)

(21) Appl. No.: 10/980,662

(22) Filed: Nov. 3, 2004

(30) Foreign Application Priority Data
Nov. 7, 2003 (JP) 2003-379047
Oct. 13, 2004 (JP) 2004-299211

(51) Int. Cl. G03B 23/08

(52) U.S. Cl. 353/27 R

(57) ABSTRACT

There are provided a light source 16 that emits light, an optical sheet 14 that adjusts the optical path of the light emitted from the light source 16 in such a way that a liquid crystal panel 12 is irradiated with the light from behind, and a frame 13 that permits the optical sheet 14 to be kept in position behind the liquid crystal panel 12. The optical sheet 14 is supported at one point on the frame 13. When the optical sheet 14 is rectangular, advisably it is supported on the frame 13 substantially at the center of one side of the optical sheet 14. For stable fitting, preferably the optical sheet 14 is supported on the frame 13 substantially at the center of that side of the optical sheet 14 which, in actual use, is located at the top with respect to the direction of gravity.

### BACKGROUND OF THE INVENTION

1. Field of the Invention

The present invention relates to a backlight device, and to a liquid crystal display device provided therewith. More particularly, the present invention relates to a backlight device provided with an optical sheet having a predetermined optical function, and to a liquid crystal display device provided with such a backlight device.

2. Description of Related Art

Conventionally, display apparatuses such as television monitors have been typically using CRTs (cathode ray tubes). In recent years, flat panel displays have come to be used increasingly widely not only for their space-saving and power-saving advantages but also for their improved viewing angle, contrast, and color reproduction characteristics. Among such flat panel displays, liquid crystal display devices in particular are now so popular as if to supersede CRTs.

In a liquid crystal display device, the liquid crystal itself does not emit light, and hence image display is achieved in the following manner. While a display area formed of liquid crystal is irradiated with backlight or external light, the alignment of the liquid crystal is controlled with a drive circuit, and thereby the amount of light transmitted through the liquid crystal is controlled in such a way as to produce an image. Here, for the purpose of irradiating the liquid crystal, which forms the display area, uniformly with the light from a light source such as a backlight, an optical sheet, such as a diffusive sheet or prism sheet, is laid between the backlight and the liquid crystal. Such optical sheets are mostly formed of resin, and hence they expand and contract as the ambient temperature varies. This requires one to take the expansion and contraction of an optical sheet into consideration when designing how to fix it inside a display device.

FIG. 23 shows how an optical sheet is conventionally fitted. A frame 1 has a frame portion 1a and a stepped support portion 1b. The stepped support portion 1b is thinner than the frame portion 1a, and projects inward from the inner edge of the frame portion 1a. When a rectangular optical sheet 2 is fitted to this frame 1, first the optical sheet 2 is fitted inside the frame portion 1a of the frame 1, and is then fixed in position with an outer edge portion thereof held between the stepped support portion 1b of the frame 1 and an unillustrated support member.

When the optical sheet 2 is fitted to the frame 1 in this way, as the ambient temperature varies, the optical sheet 2 expands and contracts radially with respect to a central portion thereof, as indicated by arrows in FIG. 23. Consequently, stresses tend to concentrate in the central portion of the optical sheet 2. This causes the optical sheet 2 to be deformed with wrinkles, badly affecting the optical characteristics of the liquid crystal display device.

An attempt to avoid this is made in Japanese Patent Application Laid-Open No. H11-337942. According to this publication, as shown in FIG. 24, in an illumination device, for the purpose of preventing the wrinkling and warping of an optical sheet, projection-like engagement pins 5 are formed on a frame 6b, and holes 4a are formed in a light-diffusing sheet 4. The engagement pins 5 are put through the holes 4a, and are then fitted into holes 7 in an upper frame 6. In this way, the light-diffusing sheet 4 is fitted to the frame 6b.

In the embodiment specifically disclosed in the publication mentioned above, however, only two holes 4a are formed in the light-diffusing sheet 4. Consequently, as the light-diffusing sheet 4 expands and contracts, stresses concentrate around the two holes 4a, causing the light-diffusing sheet 4 to wrinkle or warp. Considering the current trend toward increasingly large liquid crystal display devices in the fields of television monitors and the like, the fitting method described above is insufficient to overcome the increasingly striking effects of the concentration of stresses resulting from the expansion and contraction of an optical sheet.

### SUMMARY OF THE INVENTION

In view of the conventionally encountered problems discussed above, it is an object of the present invention to provide a backlight device and a liquid crystal display device in which, even when an optical sheet expands or contracts as the ambient temperature varies, the optical sheet does not wrinkle or warp.

According to one aspect of the present invention, a backlight device for use in a liquid crystal display device in which a liquid crystal panel is irradiated with light from behind is provided with: a light source that emits light; an optical sheet that adjusts the optical path of the light emitted from the light source in such a way that the liquid crystal panel is irradiated with the light from behind; and a frame that permits the optical sheet to be kept in position behind the liquid crystal panel. Here, the optical sheet is supported at one point on the frame. It should be understood that, in the present specification, an optical sheet denotes one that diffuses, condenses, or otherwise processes the light emitted from a light source by refracting, diffracting, reflecting, or otherwise acting upon it so that a liquid crystal panel is irradiated with the light from behind. Specifically, an optical sheet may be a diffusive sheet, prism sheet, polarization-selective reflective/transmissive sheet, or the like.

With the construction described above, where the optical sheet is supported at one point on the frame, even when the optical sheet expands and contracts as the ambient temperature varies, it does so with respect to the supporting point mentioned above. This prevents undue stresses from being applied to the optical sheet. Consequently, the optical sheet does not wrinkle or warp, and hence the light with which the liquid crystal panel is irradiated through the optical sheet from the backlight device remains uniform.

Here, the frame may be so shaped as to surround the outer edge of the optical sheet. From the viewpoint of surely preventing the wrinkling or warping of the optical sheet resulting from the expansion and contraction thereof, it is preferable that, when the optical sheet is supported on the frame, a gap be left between the outer edge of the optical sheet and the inner edge of the frame.

The optical sheet may be substantially rectangular, with the optical sheet supported on the frame substantially at the center of one side of the optical sheet. From the viewpoint of stable fitting, it is preferable that the optical sheet be supported on the frame substantially at the center of that side of the optical sheet which, when the backlight device is in actual use, is located at the top with respect to the direction of gravity.

One way of supporting the optical sheet on the frame is as follows. In a portion of the frame adjoining the outer edge of the optical sheet, a recessed portion is formed that has an opening facing the outer edge of the optical sheet, and a portion of the outer edge of the optical sheet is extended outward to form a projecting portion. The projecting portion is placed in the recessed portion, and the optical sheet is supported on the frame as a result of at least one surface of the projecting portion placed in the recessed portion being pressed by a pressing member. With this construction, it is possible to reduce the distortion of the optical sheet in the direction of the thickness thereof, and to reduce the vibration of the optical sheet resulting from it being allowed to move freely. Moreover, pressing the projecting portion of the optical sheet, which projects therefrom, does not spoil the expansion and contraction of the optical sheet.

From the viewpoint of easy positioning of the optical sheet, it is preferable that, as seen in a plan view, the projecting portion and the recessed portion be geometrically similar to each other. To restrict the horizontal movement of the optical sheet, it is advisable that the pointed end of the projecting portion and the portion of the recessed portion corresponding thereto make contact with each other. To allow ample margins in the dimensional and assembly accuracy of the optical sheet, it is advisable that the pointed end of the projecting portion and the portion of the recessed portion corresponding thereto be apart from each other. To permit the pressing member to surely support the optical sheet by pressing it, it is preferable that an elastic member be placed between the pressing member and the projecting portion.

To reduce, without unduly restricting, the movement of the optical sheet in the direction of the thickness thereof, it is preferable to form, around the rim of the frame facing the optical sheet, a stepped portion deeper than the recessed portion so that, when the optical sheet is supported on the frame, a gap is left between the optical sheet and the stepped portion.

Another way of supporting the optical sheet on the frame is as follows. A hole is formed in the optical sheet and a pin-like member is formed on the frame. The optical sheet is supported on the frame as a result of the pin-like member being put through the hole of the optical sheet. Here, it is preferable that a portion of the outer edge of the optical sheet be extended outward to form a projecting portion, with the hole formed in this projecting portion.

Still another way of supporting the optical sheet on the frame is as follows. The frame has an upper frame and a lower frame that can be put together. The optical sheet is supported between the upper and lower frames as a result of the upper and lower frames being put together.

Here, it is preferable that a portion of the outer edge of the optical sheet be extended outward to form a projecting portion so that, when the upper and lower frames are put together, the optical sheet is supported on the frame as a result of the projecting portion being held between the upper and lower frames.

In this case, to permit the optical sheet to be surely supported, it is preferable to form, in a portion of at least one of the upper and lower frames adjoining the outer edge of the optical sheet, a recessed portion that has an opening facing the outer edge of the optical sheet, form a projection on at least one of the bottom surface of the recessed portion or the surface facing that surface, and place the projecting portion of the optical sheet in the recessed portion so that the optical sheet is supported on the frame as a result of, when the upper and lower frames are put together, the projection pressing the projecting portion.

A hole may be formed in the optical sheet, with a pin-like member formed on at least one of the upper and lower frames, so that the optical sheet is supported on the frame as a result of the pin-like member being put through the hole of the optical sheet. Here, to allow ample margins in the dimensional and assembly accuracy of the upper and lower frames, it is preferable that a through hole through which to put the pin-like member or a groove in which to fit the pin-like member be formed in the upper or lower frame. It is preferable that a portion of the outer edge of the optical sheet be extended outward to form a projecting portion, with the hole formed in this projecting portion.

To surely prevent the optical sheet from dropping off the upper and lower frames, and to permit the optical sheet to be fixed with the upper and lower frames put together, a fixing member may be provided that keeps the upper and lower frames fixed together, with an engagement portion that engages with the fixing member provided in a tip portion of the pin-like portion.

To further prevent the optical sheet from wrinkling or warping, it is preferable that, when the upper and lower frames are put together, gaps be left between the optical sheet and the upper and lower frames in the direction along the axis of the pin-like member.

From the viewpoint of facilitating the fitting of the optical sheet on the frame, on at least one of a side of the optical sheet and the side of the frame that faces that side of the optical sheet, a positioning projection may be formed to project toward the other. Here, it is preferable that the side on which the positioning projection is formed be at least one of the side of the optical sheet at which the optical sheet is supported and the side of the frame that faces that side of the optical sheet. It is preferable that, as the positioning projection, two positioning projections be formed on both sides of the supporting point.

According to another aspect of the present invention, a liquid crystal display device is provided with the backlight device described above.

According to still another aspect of the present invention, in an optical sheet that is designed for use in a liquid crystal display device and that is fitted behind the liquid crystal display device by being supported on a frame, a portion of the outer edge of the optical sheet is extended to form a projecting portion, and this projecting portion permits the optical sheet to be supported at one point on the frame. Here, a hole may formed in the projecting portion so that the optical sheet is supported at one point on the frame as a result of a pin-like member formed on the frame being put through the hole.

### BRIEF DESCRIPTION OF THE DRAWINGS

FIG. 1 is a sectional view schematically showing the liquid crystal display device of a first embodiment of the invention;

FIG. 2 is a plan view, as seen from below, showing how the optical sheet is fitted on the frame;

FIG. 3 is an enlarged detail view of FIG. 2;

FIG. 4 is an enlarged detail view of FIG. 2;

FIG. 5 is a sectional view of the recessed portion of the frame;

FIG. 6 is a sectional view showing how the projecting portion of the optical sheet is fitted into the recessed portion of the frame;

FIG. 7 is a sectional view showing how the projecting portion of the optical sheet is held;

FIG. 8 is a plan view showing how the optical sheet is fitted on the frame in a second embodiment of the invention;

FIG. 9 is an enlarged detail view of FIG. 8;

FIG. 10 is an enlarged detail view showing a third embodiment of the invention;

FIG. 11 a sectional view schematically showing the liquid crystal display device of a fourth embodiment of the invention;

FIG. 12 a sectional view schematically showing the liquid crystal display device of a fifth embodiment of the invention;

FIG. 13 is a sectional view schematically showing a modified example of a liquid crystal display device;

FIG. 14 is a perspective detail view showing another example of how the optical sheet is supported;

FIG. 15 is a sectional view showing another embodiment of a liquid crystal display device according to the present invention;

FIG. 16 is a perspective view showing how the optical sheet is supported;

FIG. 17 is a vertical sectional view of FIG. 16;

FIG. 18 is a perspective view showing another example of how the optical sheet is supported;

FIG. 19 is a perspective view showing another example of how the optical sheet is supported;

FIG. 20 is a vertical sectional view showing another example of how the optical sheet is supported;

FIG. 21 is a vertical sectional view showing another example of how the optical sheet is supported;

FIG. 22 is a perspective view showing another example of the frame used in the present invention;

FIG. 23 is a plan view showing a conventional example; and

FIG. 24 is a diagram showing another conventional example.

### DETAILED DESCRIPTION OF PREFERRED EMBODIMENTS

Hereinafter, backlight devices and liquid crystal display devices according to the present invention will be described with reference to the drawings. It should be understood that these embodiments are not intended to limit the implementation of the present invention in any way.

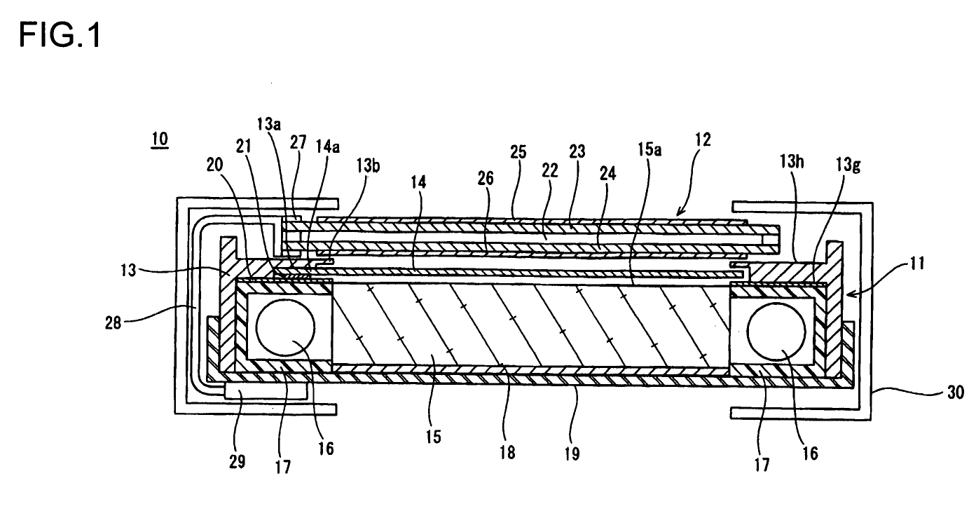

FIG. 1 is a sectional view schematically showing the backlight device and the liquid crystal display device of a first embodiment of the invention. In the liquid crystal display device 10 shown in this figure, a backlight device 11 having an optical sheet laid on the light-emitting side thereof and a liquid crystal panel 12 are held together by a metal bezel 30.

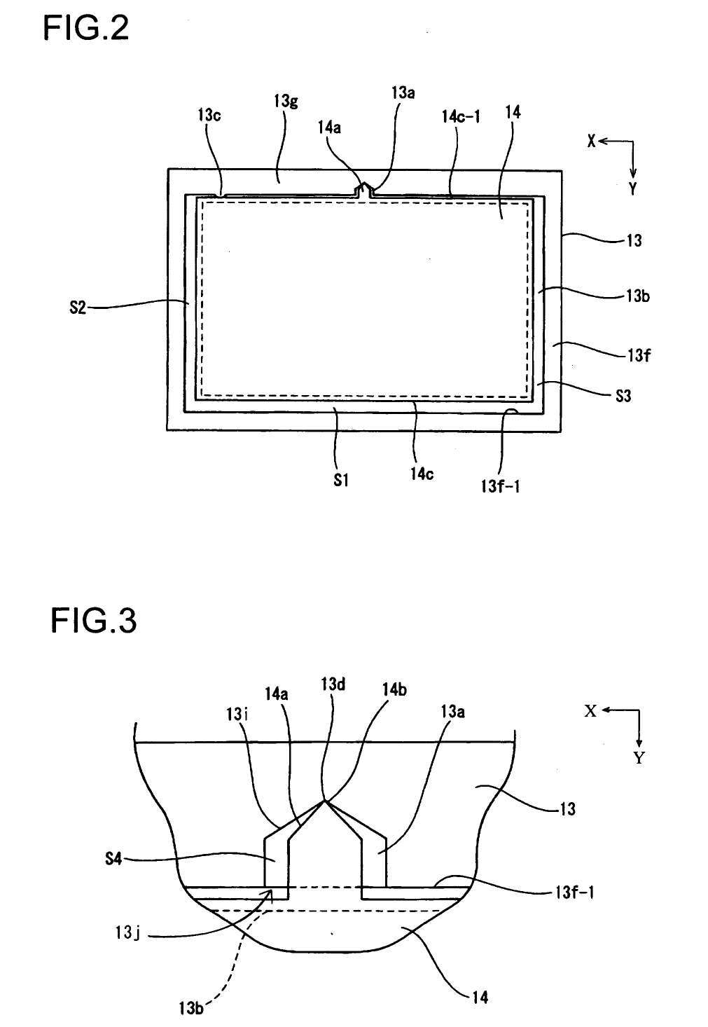

The backlight device 11 includes: a case 19 having a C-shaped cross-section; a reflective sheet 18 laid over the floor surface of the case 19 and formed of PET foam; a rectangular light guide plate 15 arranged on top of the reflective sheet 18 and formed by molding acrylic resin; a pair of linear light sources (cold cathode fluorescent lamps) 16 arranged along opposite ends of the light guide plate 15 so as to face each other; lamp holders 17 having a C-shaped cross-section and arranged to surround the linear light sources 16; an optical sheet 14 arranged on the light-exit side of the light guide plate 15; a rectangular frame 13 that holds the optical sheet 14 and other components inside it; a pressing member 20 that is placed between the top surface of the lamp holders 17 and the frame 13; and an elastic member 21 that is placed between the pressing member 20 and a projecting portion 14a (see FIG. 2) of the optical sheet 14. The light-exit-side surface 15a of the light guide plate 15 is made mat by sand blasting or the like so that the light exiting from the light guide plate 15 is diffused there.

The liquid crystal panel 12 includes: transparent substrates 23 and 24 that are arranged so as to face each other; liquid crystal 22 that is sealed between the transparent substrates 23 and 24; and polarizer plates 25 and 26 that are laid over the outer surfaces of the transparent substrates 23 and 24 to make uniform the direction of the polarization plane of the incident and emergent light. Seen in a plan view, the liquid crystal panel 12 has a large number of pixels arrayed in a matrix.

The liquid crystal panel 12 is driven by a driver 27, to which is connected, through a flexible printed circuit board 28, a circuit board 29 for controlling the alignment of the liquid crystal 22.

The liquid crystal display device 10 shown in FIG. 1 adopts a backlight mechanism of the so-called edge light type, wherein the linear light sources 16 are arranged along opposite ends of the light guide plate 15. It should be understood, however, that the present invention may be applied to any other type of backlight mechanism; for example it may be applied to a backlight mechanism of the direct-lit type, wherein a light source is arranged behind the display surface of the liquid crystal panel 12. The light guide plate 15 may have any other shape than that of a flat plate; for example, it may have a shape with a wedge-like cross section.

The optical sheet 14 serves to diffuse, condense, or otherwise process the light emerging from the light guide plate 15 by refracting, diffracting, reflecting, or otherwise acting upon it so that the liquid crystal panel 12 is irradiated with the light from behind. Examples of such optical sheets include: a prism sheet having a plurality of prisms, each having an isosceles-triangle-shaped cross section, arranged periodically on the light-exit-side surface thereof; a polarization-selective reflective/transmissive sheet (for example, the model “DBEF” manufactured by 3M) that selectively reflects light so that the light is not absorbed by the polarizer plate 26 of the liquid crystal panel 12; and a diffusive sheet (for example, the model “PC-03” manufactured by Keiwa Shoko) that diffuses light. Either a single sheet of one of these or a plurality of sheets of them laid over one another are used. Practical examples of how such optical sheets are combined together are, from the light guide plate to the liquid crystal panel: a diffusive sheet, then a prism sheet, and then a polarization-selective reflective/transmissive sheet; a diffusive sheet, then a prism sheet, and then a diffusive sheet; a diffusive sheet, then a diffusive sheet, and then a diffusive sheet; and a diffusive sheet, and then a diffusive sheet. These optical sheets are about 0.1 mm to 0.5 mm thick, and their size as seen in a plan view varies according to the size of the display screen. In FIG. 1, for the sake of convenience, only a single optical sheet 14 is used.

As shown in FIG. 2, the optical sheet 14 has a projecting portion 14a that extends outward from the center of one side 14c-1 of the rectangular edge 14c thereof. As shown in FIG. 3, the tip end of the projecting portion 14a is triangular so as to have a pointed end 14b.

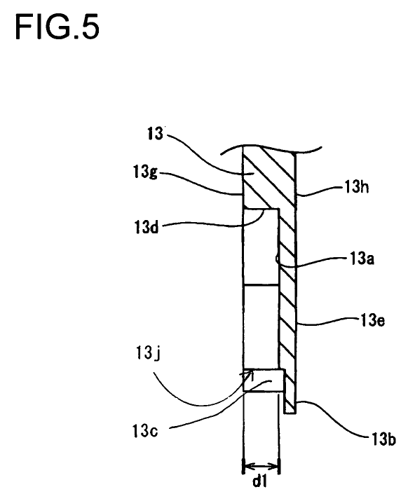

On the other hand, as shown in FIG. 2, the frame 13 has a rectangular frame portion 13f and a stepped portion 13b. The stepped portion 13b is thinner than the frame portion 13f, and projects inward from a lower part of the inner edge 13f-1 of the frame portion 13f Substantially at the center of one side of the frame portion 13f, in the obverse surface 13g thereof, a recessed portion 13a is formed by being cut from the inner edge 13f-1 side. That is, the recessed portion 13a has an opening 13j on the inner edge 13f-1 side. As shown in FIG. 3, the floor surface 13i of the recessed portion 13a is shaped like a home base, with a pointed end 13d at the vertex. Moreover, as shown in FIG. 5, the depth d1 of the recessed portion 13a is smaller than the depth of the stepped portion 13b, but is greater than the thickness of the projecting portion 14a (shown in FIG. 3) of the optical sheet 14. Furthermore, as shown in FIG. 2, on the same side of the frame portion 13f in which the recessed portion 13a is formed, but in a different place therefrom, a positioning projection 13c having a arc-shaped tip end is formed so as to project inward from the inner edge 13f-1. The recessed portion 13a is formed in a place that is located at the top when the liquid crystal display device 10 is actually used.

The pressing member 20 is formed of resin, and is shaped like a flat plate. The elastic member 21 is formed of rubber, resin, or the like, and is given a thickness equal to the thickness of the projecting portion 14a subtracted from the depth d1 of the recessed portion 13a.

Next, how the optical sheet 14 is fitted to the frame 13 will be described. As shown in FIG. 2, the projecting portion 14a of the optical sheet 14 is placed in the recessed portion 13a of the frame 13, and the optical sheet 14 is fitted inside the frame portion 13f. Then the position of the optical sheet 14 is adjusted so that the edge 14c of the side 14c-1 of the optical sheet 14 where the projecting portion 14a is formed makes contact with the positioning projection 13c.

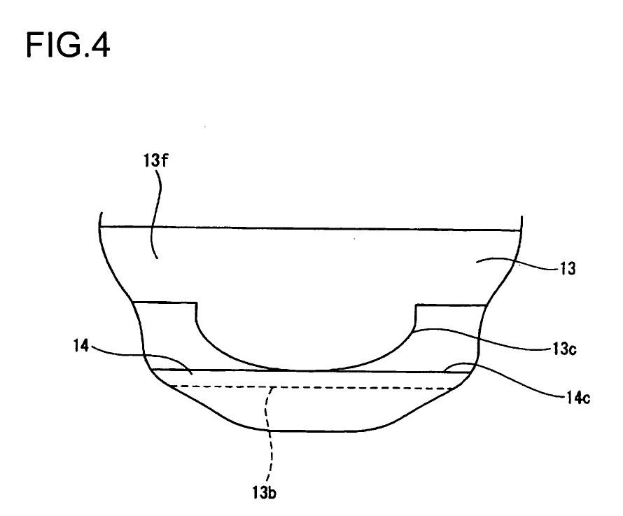

At this time, as shown in FIG. 3, the pointed end 14b of the projecting portion 14a makes point contact with the pointed end 13d of the recessed portion 13a, and thereby restricts the movement of the optical sheet 14 in the X direction indicated in the figure. At the same time, as shown in FIG. 4, the edge 14c of the optical sheet 14 makes contact with the positioning projection 13c, and thereby restricts the movement of the optical sheet 14 in the Y direction indicated in the figure. Here, since the positioning projection 13c is arc-shaped, it does not restrict the X-direction movement of the optical sheet 14. Except at the pointed end 14b, the outer edge of the projecting portion 14a makes no contact with the side wall of the recessed portion 13a, and hence a gap S4 is left between them. Needless to say, the projecting portion 14a and the recessed portion 13a may be closely fitted together.

When the optical sheet 14 is fitted to the frame 13 in this way, as shown in FIG. 2, gaps S1 and S2 are left between the inner edge 13f-1 of the frame portion 13f and the bottom and both side edges of the optical sheet 14.

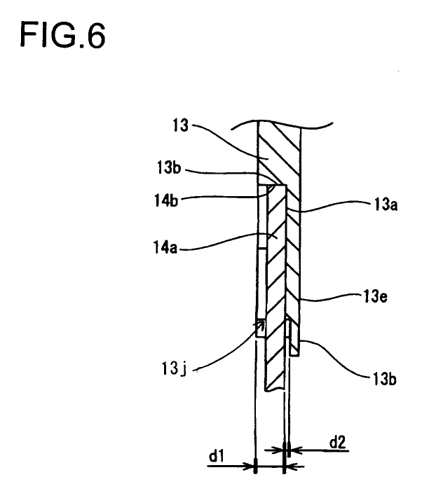

As shown in FIG. 6, the depth d1 of the recessed portion 13a is greater than the thickness of the projecting portion 14a of the optical sheet 14. Moreover, the depth of the stepped portion 13b is greater than the depth d1 of the recessed portion 13a. Hence, when the projecting portion 14a of the optical sheet 14 is kept in contact with the floor surface of the recessed portion 13a, a gap d2 is left between the optical sheet 14 and the stepped portion 13b. This helps reduce, without unduly restricting, the movement of the optical sheet in the direction of the thickness thereof.

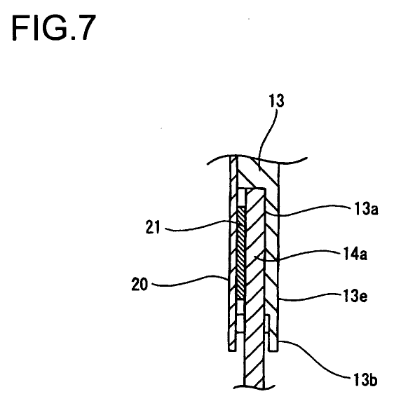

As shown in FIG. 7, the projecting portion 14a of the optical sheet 14 is pressed against a thin portion 13e by the pressing member 20, with the elastic member 21 placed between them. This permits the optical sheet 14 to be held by the frame 13. Here, the total thickness of the projecting portion 14a and the elastic member 21 is equal to the depth d1 of the recessed portion 13a. Then, as shown in FIG. 1, the other components are fitted to make the liquid crystal display device 10. It should be noted that the frame 13 is so arranged that the thin portion 13e of the recessed portion 13a is located on the liquid crystal panel 12 side of the optical sheet 14.

As described above, the optical sheet 14 is fitted to the frame 13 with the projecting portion 14a of the optical sheet 14 placed in the recessed portion 13a of the frame 13 and with only the projecting portion 14a pressed by the pressing member 20 and the elastic member 21. Consequently, even when the optical sheet 14 expands and contracts as the ambient temperature varies, it does so freely with respect to the projecting portion 14a. Hence, no undue stresses are applied to the optical sheet 14, which thus does not wrinkle or warp. In this way, it is possible to make uniform the light with which the liquid crystal panel is irradiated from the backlight device.

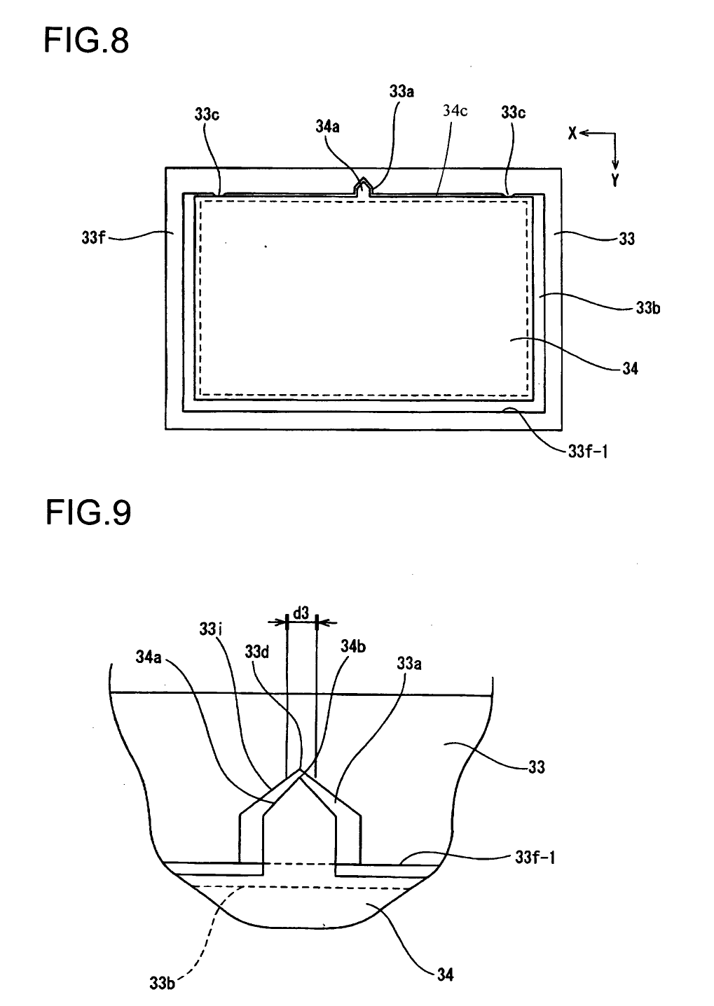

FIGS. 8 and 9 show the backlight device and the liquid crystal display device of a second embodiment of the invention. In the following description, no explanations will be repeated of such features as are found also in the previously described embodiment, and chiefly the differences therefrom will be discussed.

The frame 33 has a rectangular frame portion 33f and a stepped portion 33b. The stepped portion 33b is thinner than the frame portion 33f, and projects inward from the inner edge 33f-1 of the frame portion 33f In the frame portion 33f, a recessed portion 33a is formed that has the same shape as in the previously described embodiment. On the side where the recessed portion 33a is formed, on both sides thereof, positioning projections 33c are formed that each have the same shape as in the previously described embodiment.

The optical sheet 34 is rectangular, and has a projecting portion 34a that projects outward from the center of one side 34c thereof. The tip portion of the projecting portion 34a is triangular so as to have a pointed end 34b (shown in FIG. 9). As shown in FIG. 9, the length over which the projecting portion 34a projects is smaller than in the previously described embodiment, and the pointed end 34b thereof is kept apart from the pointed end 33d of the floor surface 33i of the recessed portion 33a. Needless to say, the recessed portion 33a may be made deeper in order thereby to keep the pointed end 34b of the projecting portion 34a apart from the pointed end 33d of the recessed portion 33a.

When the optical sheet 34 constructed as described above is fitted to the frame 33, the positioning projections 33c achieve the positioning of the optical sheet 34 in the Y direction indicated in the figure. On the other hand, with respect to the positioning in the X direction indicated in the figure, since the pointed end 34b of the projecting portion 34a makes no contact with the pointed end 33d of the recessed portion 33a, the gap between them permits the optical sheet 34 to move over a distance d3 in the X direction. This produces margins in the dimensional and assembly accuracy of the optical sheet 34 and the frame 33.

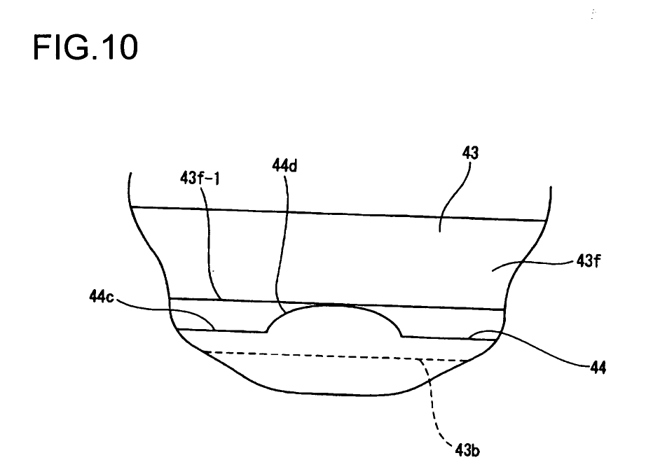

FIG. 10 shows the backlight device and the liquid crystal display device of a third embodiment of the invention. This embodiment differs from the first embodiment in that, instead of a positioning projection formed on the frame 43, a positioning projection 44d is formed on the optical sheet 44.

Specifically, in the optical sheet 44 shown in FIG. 10, on the same side thereof where the projecting portion (not illustrated) is formed, but in a different place therefrom, an arc-shaped positioning projection 44d is formed, and this is kept in contact with the inner edge 43f-1 of the frame portion 43f of the frame 43 to achieve positioning.

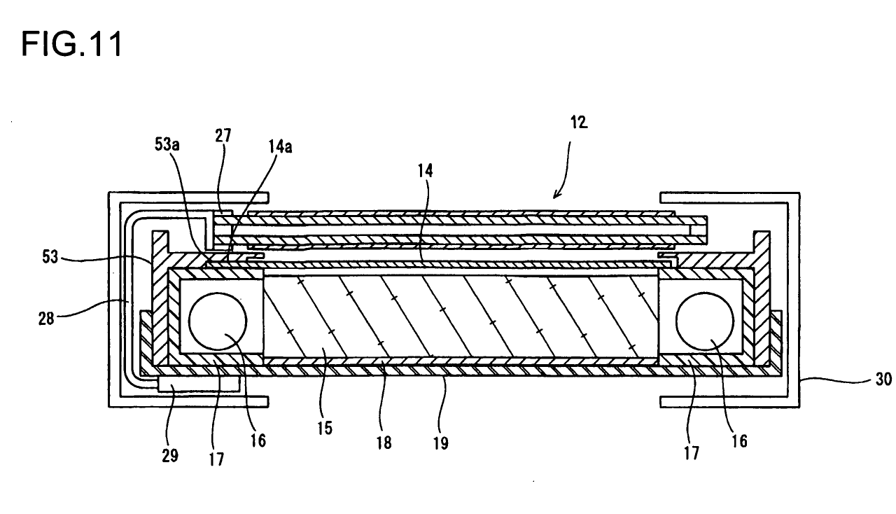

FIG. 11 shows the backlight device and the liquid crystal display device of a fourth embodiment of the invention. This embodiment differs from the first embodiment in that the depth of the recessed portion 53a in the frame 53 is made approximately equal to the thickness of the projecting portion 14a of the optical sheet 14.

With the construction described above, when the projecting portion 14a is placed in the recessed portion 53a, the top surface of the frame 53 is level with the top surface of the projecting portion 14a. This permits the projecting portion 14a of the optical sheet 14 to be held between the top surface of the lamp holders 17 and the recessed portion 53a. Moreover, quite naturally, except in the projecting portion 14a, the entire optical sheet 14 is left freely moving, preventing stresses from being applied to the optical sheet 14 even when it expands and contracts. The thickness of the projecting portion 14a of the optical sheet 14 may be made slightly greater than the depth of the recessed portion 53a of the frame 53.

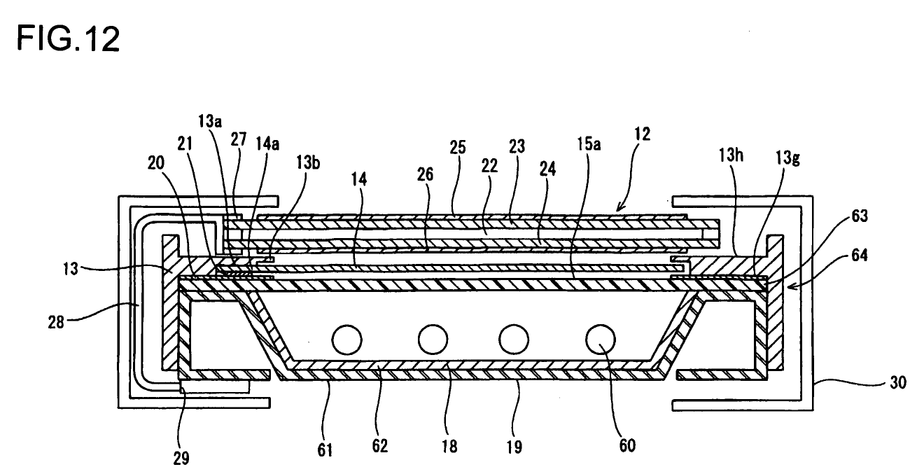

FIG. 12 shows the backlight device and the liquid crystal display device of a fifth embodiment of the invention. This embodiment differs from the first embodiment in that a backlight 64 of the direct-lit type is used.

Specifically, in the liquid crystal display device shown in FIG. 12, immediately behind the liquid crystal panel 12, four linear light sources 60 are arranged at equal intervals, and the linear light sources 60 are covered from behind with a case 61 that has a reflective sheet 62 laid on the inner surface thereof and that has a substantially C-shaped cross section. Moreover, between the linear light sources 60 and the optical sheet 14, a diffusive plate 63 is arranged to make uniform the light from the linear light sources 60.

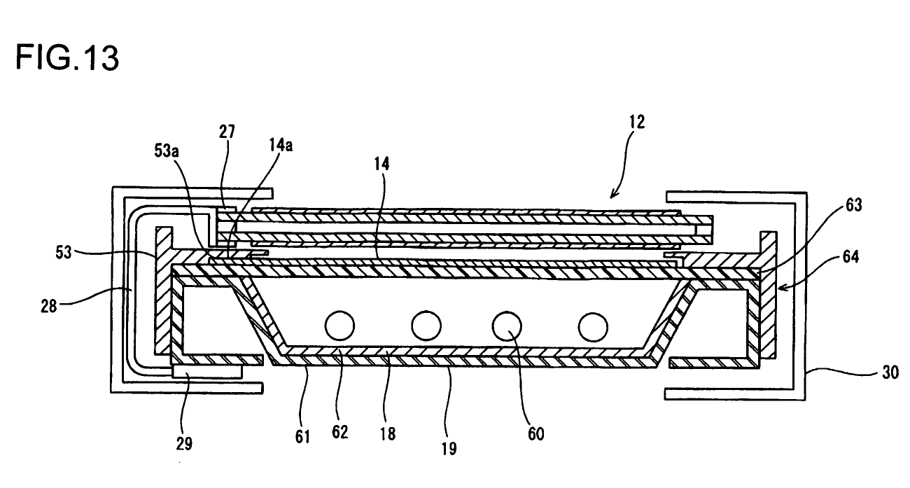

Moreover, in this embodiment, as in the fourth embodiment described above, as shown in FIG. 13, the depth of the recessed portion 53a of the frame 53 may be made approximately equal to the thickness of the projecting portion 14a of the optical sheet 14.

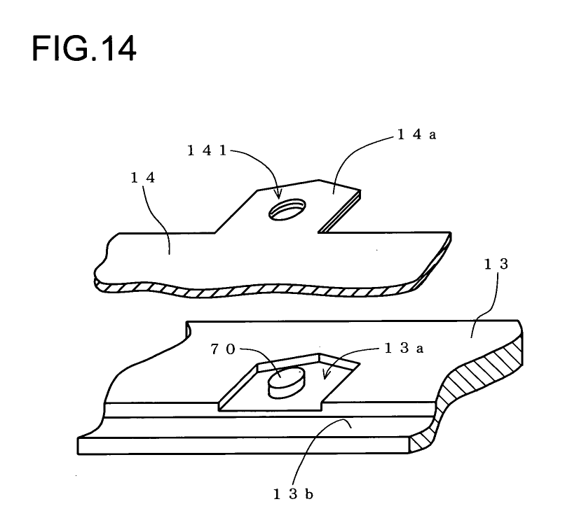

In all the embodiments described thus far, the optical sheet is pressed by the pressing member so that the optical sheet is supported by being held between the frame and the pressing member. Alternatively, it is also possible to form a hole in the optical sheet and a pin-like member on the frame so that the optical sheet is supported on the frame as a result of the pin-like member being put through the hole. FIG. 14 shows an example of this type of supporting structure.

In FIG. 14, substantially at the center of the floor surface of the recessed portion 13a of the frame 13, a cylindrical pin-like member 70 is formed to project upright therefrom. The height of the pin-like member 70 is equal to the depth of the recessed portion 13a. On the other hand, in the projecting portion 14a formed on the optical sheet 14, a through hole 141 is formed. The diameter of the through hole 141 is equal to or slightly greater than that of the pin-like member 70.

When the optical sheet 14 is supported on the frame 13, the pin-like member 70 on the frame 13 is put through the through hole 141 in the optical sheet 14. Then a predetermined component, for example the lamp holders 17 (shown in FIG. 11), is fitted on top of the frame 13. This permits the tip-end face of the pin-like member 70 to make contact with the surface of the predetermined component, and thereby permits the optical sheet 14 to be fitted on the frame 13 while preventing the optical sheet 14 from dropping off the pin-like member 70.

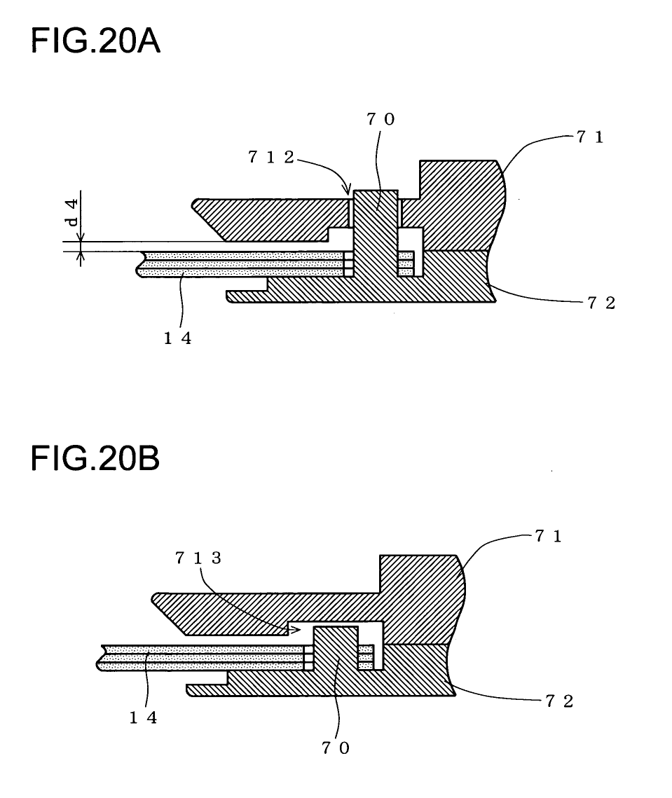

Needless to say, it is also possible to form the through hole 141 at the edge of the optical sheet 14 without forming the projecting portion 14a thereon and then fit the optical sheet 14 on the frame 13. Alternatively, as will be described later, it is also possible to give the pin-like member 70 a height greater than the depth of the recessed portion 13a and form, in a predetermined member (for example, the lamp holders 17 (shown in FIG. 11)) that is fitted on top of the frame 13, a through hole through which to put the pin-like member 70 or a groove in which to fit the pin-like member 70 (see FIG. 20).

Next, another embodiment of a backlight device and a liquid crystal display device according to the invention will be described. In the devices of the embodiments described thus far, the optical sheet is supported by being held between the frame and the pressing portion. By contrast, in the embodiments described below, a frame is used that is composed of separate pieces, namely an upper frame and a lower frame, that can be put together, and an optical sheet is supported by being held between those upper and lower frames.

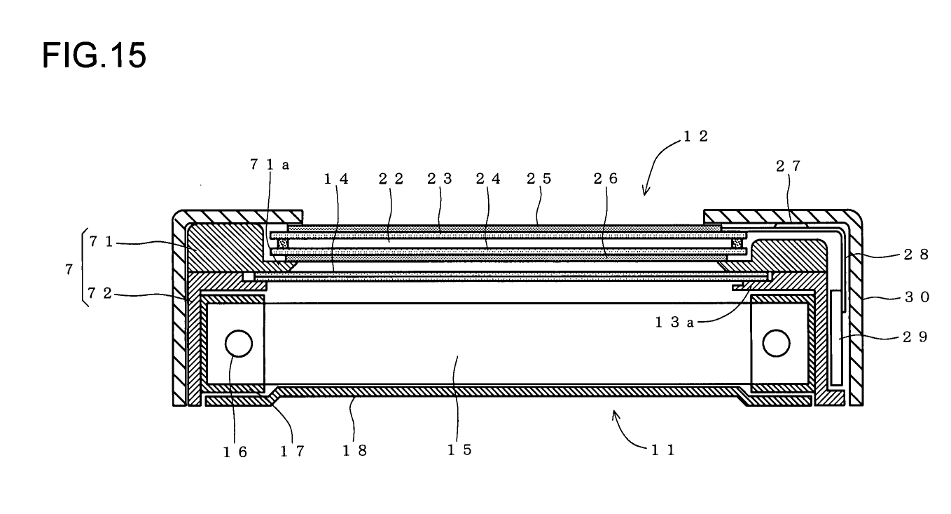

FIG. 15 is a sectional view schematically showing the backlight device and the liquid crystal display device of another embodiment of the invention. Here, such members and portions as are found also in the device shown in FIG. 1 are identified with common reference numerals. In the following description, explanations of such structures and functions as are found also in the device shown in FIG. 1 will not be repeated.

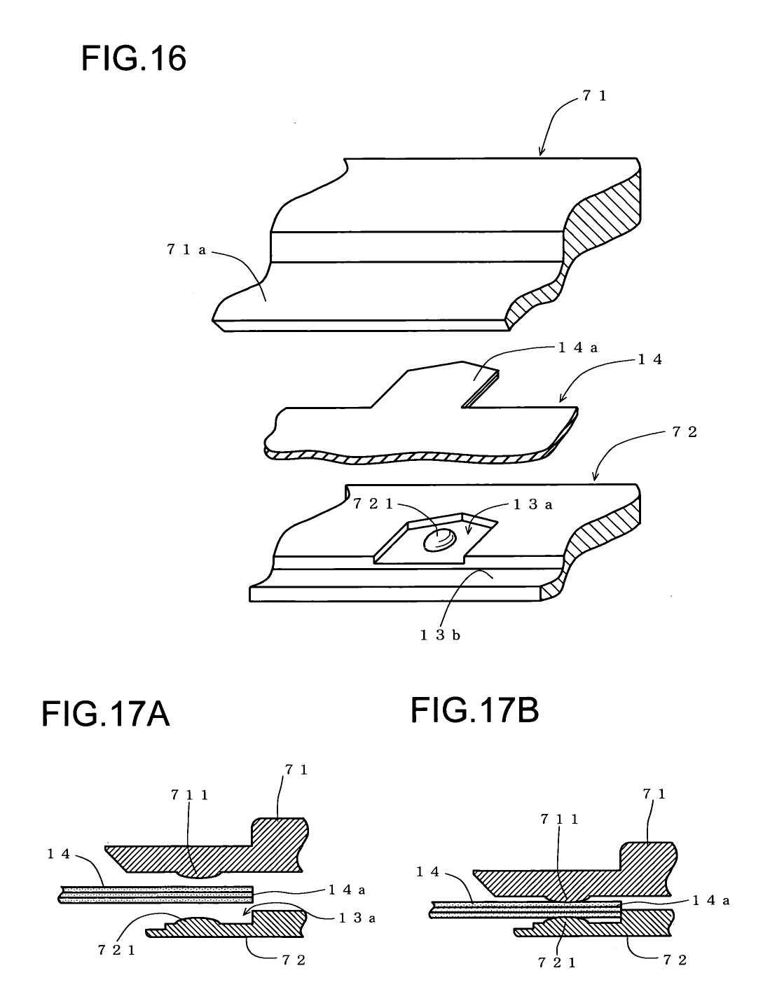

In the device shown in FIG. 15, a frame 7 is used that includes an upper frame 71 and a lower frame 72. On the upper frame 71, an overhanging portion 71a is formed that projects inward from the inner edge thereof. A liquid crystal panel 12 is fitted on this overhanging portion 71a. On the other hand, the lower frame 72 is rectangular, and is open at the top and bottom faces thereof. Inside the lower frame 72 are arranged the following components: a light guide plate 15; linear light sources 16 that are arranged along opposite ends of the light guide plate 15; lamp holders 17 that are arranged so as to envelop the linear light sources 16; and a reflective sheet 18 that is laid on the bottom surface of the light guide plate 15. With the upper and lower frames 71 and 72 put together, the frame 7 is surrounded by a metal bezel 30. The optical sheet 14 is held between the recessed portion 13a of the lower frame 72 and the bottom surface of the upper frame 71. How the optical sheet 14 is held between the upper and lower frames 71 and 72 is shown in FIG. 16.

FIG. 16 is an enlarged detail view showing how the optical sheet 14 is fitted. In the lower frame 72, a recessed portion 13a is formed so as to be open at the inner edge of the frame, and, substantially at the center of the floor surface of the recessed portion 13a, a hemispherical projection 721 is formed. Moreover, on the upper frame 71, in a position corresponding to the projection 721 on the lower frame 72, a similar projection 711 (shown in FIG. 17) is formed.

As shown FIG. 17, to support the optical sheet 14 with the upper and lower frames 71 and 72, first, the projecting portion 14a formed on the optical sheet 14 is placed in the recessed portion 13a in the lower frame 72 ((a) in the figure). Then, the upper and lower frames 71 and 72 are put together ((b) in the figure). This permits the projecting portion 14a of the optical sheet 14 to be held between the projection 711 on the upper frame 71 and the projection 721 on the lower frame 72.

There is no particular restriction on the shape and number of projections 711 and 721 formed. In this embodiment, a projection is formed on each of the upper and lower frames. It should be understood, however, that the present invention does not absolutely require a projection; so long as the optical sheet can be held between the upper and lower frames, a projection may be formed only on one of the upper and lower frames, or no projection at all may be formed. In a case where the optical sheet is held with the upper and lower frames with no projection formed, the recessed portion formed in the upper and lower frames needs to be given a depth smaller than the thickness of the optical sheet.

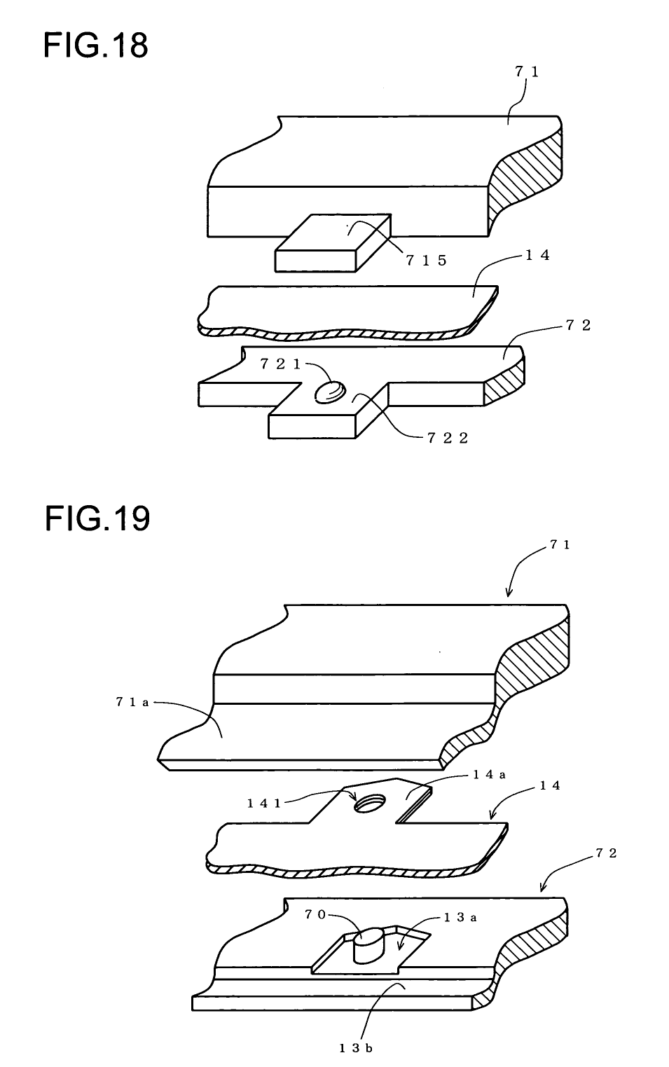

In this embodiment, the optical sheet 14 is held as a result of the projecting portion 14a formed on the optical sheet 14 being held between the upper and lower frames 71 and 72. Instead of the projecting portion formed on the optical sheet 14, as shown in FIG. 18, projecting portions 715 and 722, each having a projection 721 formed thereon, may be formed on the upper and lower frames 71 and 72 so as to face each other so that the optical sheet 14 is held between those projecting portions 715 and 722.

FIG. 19 shows another example of how the optical sheet is supported between the upper and lower frames 71 and 72. In the embodiment shown in this figure, substantially at the center of the floor surface of the recessed portion 13a of the lower frame 72, a cylindrical pin-like member 70 is formed to project upright therefrom, and, in the projecting portion 14a formed on the optical sheet 14, a through hole 141 is formed. The diameter of the through hole 141 is equal to or slightly greater than that of the pin-like member 70. The pin-like member 70 on the lower frame 72 is put through the through hole 141 in the optical sheet 14, and the lower and upper frames 72 and 71 are put together. This permits the optical sheet 14 to be fitted to the frame 7.

Here, the length of the pin-like member 70 is made equal to the depth of the recessed portion 13a so that, when the upper and lower frames 71 and 72 are put together, the top face of the pin-like member 70 just makes contact with the bottom surface of the upper frame 71. This prevents the optical sheet 14 from dropping off the pin-like member 70. The problem here is that, since each optical sheet is as thin as 0.1 mm to 0.5 mm, it is in practical terms often difficult to assemble the top face of the pin-like member 70 and the upper frame 71 with accuracy finer than that thickness. For this reason, it is recommended, as shown in FIG. 20, to make the pin-like member 70 longer and form, in the upper frame 71, a through hole 712 ((a) in the figure) through which to put the pin-like member 70 or a groove 713 ((b) in the figure) in which to fit the pin-like member 70. With this structure, it is possible to surely prevent the optical sheet 14 from dropping off the pin-like member 70 without the need to precisely adjust the length of the pin-like member 70.

Moreover, as shown in FIG. 20, it is preferable that, when the upper and lower frames 71 and 72 are put together, a gap d4 be left between the optical sheet 14 and the upper and lower frames 71 and 72. That is, by permitting the optical sheet 14 to move along the axis of the pin-like member 70, even when the optical sheet 14 expands and contracts as the ambient temperature varies, it is possible to reduce the stresses produced and thereby to prevent the optical sheet from wrinkling or warping.

Needless to say, as in the example shown in FIG. 18, it is also possible, instead of forming the projecting portion 14a on the optical sheet 14, to fit the optical sheet 14 to the frame 7 by the use of a through hole 141 formed at the edge of the optical sheet 14.

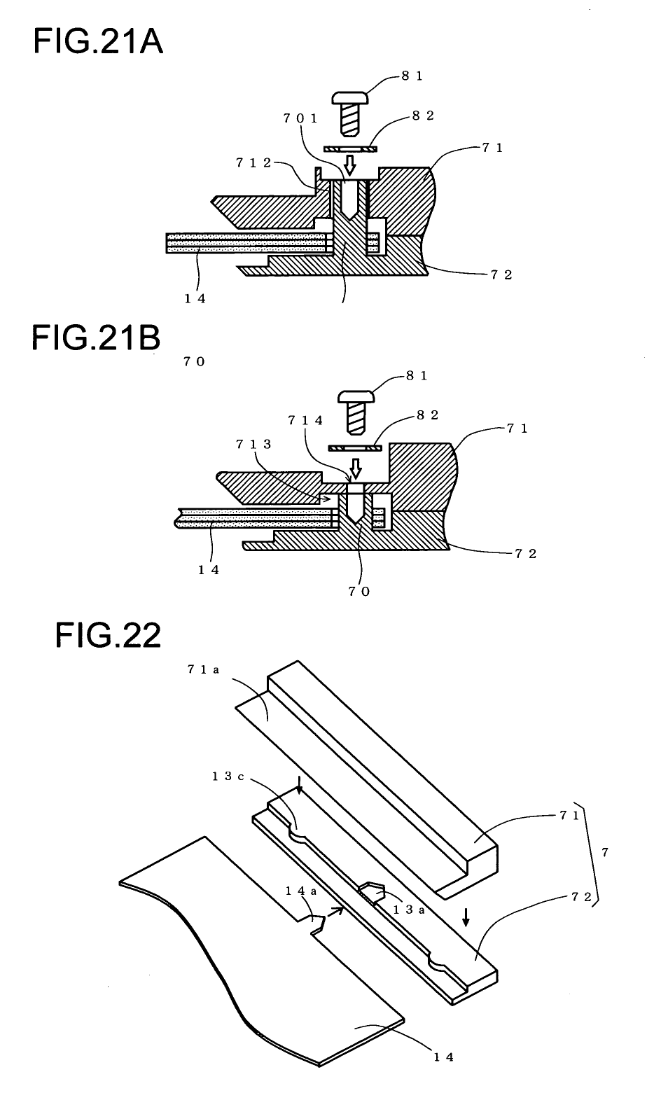

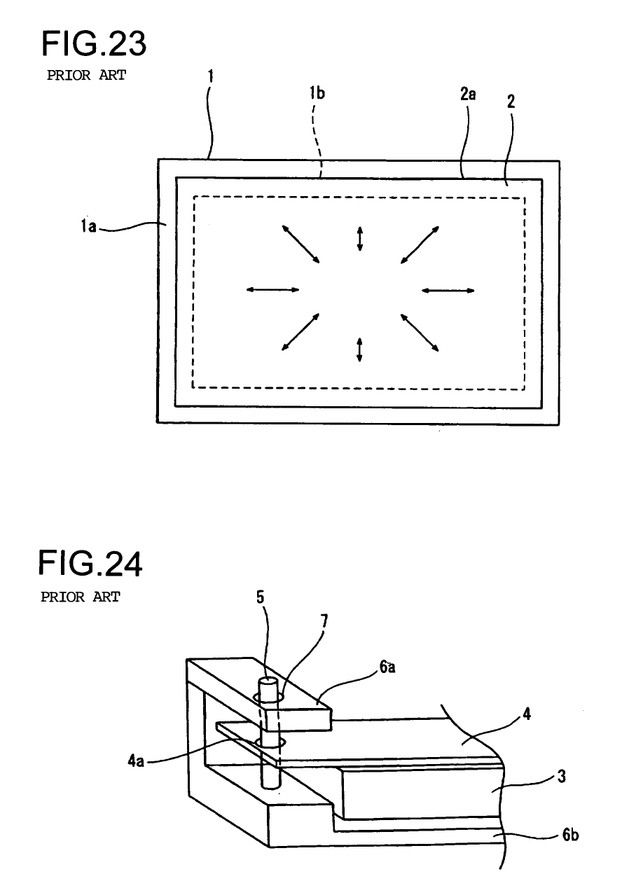

After the upper and lower frames 71 and 72 are put together, they are kept in that state by being fixed together with an unillustrated fixing member. On the other hand, since the upper and lower frames 71 and 72 are typically formed by molding resin, if they receive an external impact, they may be so deformed as to cause the optical sheet 14 to drop off the pin-like member 70. To prevent this, it is recommended to provide, in a tip portion of the pin-like member 70, an engagement portion that engages with the fixing member so that the upper and lower frames 71 and 72 are put together and fixed together by the use of the pin-like member 70. This simultaneously helps prevent the optical sheet 14 from dropping off the pin-like member 70. A practical example of such a structure is shown in FIG. 21.

FIG. 21 is a vertical sectional view around the pin-like member 70. At (a) in the figure is shown the structure corresponding to the one shown at (a) in FIG. 20. When the upper and lower frames 71 and 72 are put together, the pin-like member 70 is put through the through hole 712, and the tip portion of the pin-like member 70 is exposed at the top surface of the upper frame. In the tip-end face of the pin-like member 70, a hole (engagement portion) 701 is formed that has an unillustrated internal thread formed on the interior surface thereof. Into this hole 701, a screw (fixing member) 81 is screwed with a washer 82 placed in between. This permits the upper and lower frames 71 and 72 that are put together to be fixed together, and simultaneously surely prevents the optical sheet 14 from dropping off the pin-like member 70.

At (b) in the figure is shown the structure corresponding to the one shown at (b) in FIG. 20. When the upper and lower frames 71 and 72 are put together, the pin-like member 70 fits into the groove 713 formed in the upper frame 71. In the tip-end face of the pin-like member 70, a hole (engagement portion) 701 is formed that has an unillustrated internal thread formed on the interior surface thereof. Moreover, in the upper frame 71, a through hole 714 is formed coaxially with the hole 701. Through this hole 714, a screw 81 is screwed into the hole 701 with a washer 82 placed in between. As in the example described just above, this permits the upper and lower frames 71 and 72 that are put together to be fixed together, and simultaneously surely prevents the optical sheet 14 from dropping off the pin-like member 70.

The engagement between the fixing member and the pin-like member may be achieved by any conventionally known engagement method other than that specifically described above. For example, it is possible to form an external thread around the exterior surface of the tip portion of the pin-like member, form the tip portion of the pin-like member in such a way that it protrudes from the upper frame when the upper and lower frames are put together, and put a nut around the protruding tip portion of the pin-like member.

In the embodiments described above, the frame 7 is frame-shaped. It should be understood, however, that there is no particular restriction on the shape of the frame used in the present invention so long as it permits the optical sheet 14 to be fitted behind the liquid crystal panel 12. For example, as shown in FIG. 22, the frame may be one that is composed of an upper frame 71 and a lower frame 72 both in the shape of an elongate plate so that the projecting portion 14a on the optical sheet 14 is held between the recessed portion 13a in the lower frame 72 and the upper frame 71.

1. A backlight device for use in a liquid crystal display device in which a liquid crystal panel is irradiated with light from behind, the backlight device comprising:
a light source that emits light;
an optical sheet that adjusts an optical path of the light emitted from the light source in such a way that the liquid crystal panel is irradiated with the light from behind; and
a frame that permits the optical sheet to be kept in position behind the liquid crystal panel,
wherein the optical sheet is supported at one point on the frame.

2. The backlight device of claim 1,
wherein the frame is so shaped as to surround an outer edge of the optical sheet.

3. The backlight device of claim 2,
wherein, when the optical sheet is supported on the frame, a gap is left between the outer edge of the optical sheet and an inner edge of the frame.

4. The backlight device of claim 1,
wherein the optical sheet is substantially rectangular, and the optical sheet is supported on the frame substantially at a center of one side of the optical sheet.

5. The backlight device of claim 4,
wherein the optical sheet is supported on the frame substantially at a center of that side of the optical sheet which, when the backlight device is in actual use, is located at a top with respect to a direction of gravity.

6. The backlight device of claim 1, wherein
in a portion of the frame adjoining the outer edge of the optical sheet, a recessed portion is formed that has an opening facing the outer edge of the optical sheet,
a portion of the outer edge of the optical sheet is extended outward to form a projecting portion,
the projecting portion is placed in the recessed portion, and
the optical sheet is supported on the frame as a result of at least one surface of the projecting portion placed in the recessed portion being pressed by a pressing member.

7. The backlight device of claim 6,
wherein, as seen in a plan view, the projecting portion and the recessed portion are geometrically similar to each other.

8. The backlight device of claim 7,
wherein, as seen in a plan view, a pointed end of the projecting portion and a portion of the recessed portion corresponding thereto make contact with each other.

9. The backlight device of claim 7,
wherein, as seen in a plan view, a pointed end of the projecting portion and a portion of the recessed portion corresponding thereto are apart from each other.

10. The backlight device of claim 6,
wherein an elastic member is placed between the pressing member and the projecting portion.

11. The backlight device of claim 6,
wherein, around a rim of the frame facing the optical sheet, a stepped portion deeper than the recessed portion is formed so that, when the optical sheet is supported on the frame, a gap is left between the optical sheet and the stepped portion.

12. The backlight device of claim 1,
wherein a hole is formed in the optical sheet and a pin-like member is formed on the frame so that the optical sheet is supported on the frame as a result of the pin-like member being put through the hole of the optical sheet.

13. The backlight device of claim 12,
wherein a portion of the outer edge of the optical sheet is extended outward to form a projecting portion, and the hole is formed in the projecting portion.

14. The backlight device of claim 1,
wherein the frame has an upper frame and a lower frame that can be put together so that the optical sheet is supported between the upper and lower frames as a result of the upper and lower frames being put together.

15. The backlight device of claim 14,
wherein a portion of the outer edge of the optical sheet is extended outward to form a projecting portion so that, when the upper and lower frames are put together, the optical sheet is supported on the frame as a result of the projecting portion being held between the upper and lower frames.

16. The backlight device of claim 15, wherein
in a portion of at least one of the upper and lower frames adjoining the outer edge of the optical sheet, a recessed portion is formed that has an opening facing the outer edge of the optical sheet,
a projection is formed on at least one of a bottom surface of the recessed portion or a surface facing the bottom surface,
the projecting portion of the optical sheet is placed in the recessed portion, and
the optical sheet is supported on the frame as a result of, when the upper and lower frames are put together, the projection pressing the projecting portion.

17. The backlight device of claim 14,
wherein a hole is formed in the optical sheet and a pin-like member is formed on at least one of the upper and lower frames so that the optical sheet is supported on the frame as a result of the pin-like member being put through the hole of the optical sheet.

18. The backlight device of claim 17,
wherein a through hole through which to put the pin-like member or a groove in which to fit the pin-like member is formed in the upper or lower frame.

19. The backlight device of claim 17,
wherein a portion of the outer edge of the optical sheet is extended outward to form a projecting portion, and the hole is formed in the projecting portion.

20. The backlight device of claim 17,
wherein a fixing member is provided that keeps the upper and lower frames fixed together, and an engagement portion that engages with the fixing member is provided in a tip portion of the pin-like portion.

21. The backlight device of claim 17,
wherein, when the upper and lower frames are put together, gaps are left between the optical sheet and the upper and lower frames in a direction along an axis of the pin-like member.

22. The backlight device of claim 1,
wherein, on at least one of a side of the optical sheet and a side of the frame that faces that side of the optical sheet, a positioning projection is formed to project toward the other.

23. The backlight device of claim 22,
wherein the side on which the positioning projection is formed is at least one of a side of the optical sheet at which the optical sheet is supported and a side of the frame that faces that side of the optical sheet.

24. The backlight device of claim 23,
wherein, as the positioning projection, two positioning projections are formed on both sides of the supporting point.

25. A liquid crystal display device comprising the backlight device of claim 1.

26. An optical sheet for use in a liquid crystal display device, the optical sheet being fitted behind the liquid crystal display device by being supported on a frame,
wherein a portion of an outer edge of the optical sheet is extended to form a projecting portion, and the projecting portion permits the optical sheet to be supported at one point on the frame.

27. The optical sheet of claim 26,
wherein a hole is formed in the projecting portion, and the optical sheet is supported at one point on the frame as a result of a pin-like member formed on the frame being put through the hole.
